(19) United States
(12) Patent Application Publication
(10) Pub. No.: US 2015/0140412 A1
(43) Pub. Date: May 21, 2015

(54) SOFT-PACKAGED LITHIUM-ION BATTERY

(71) Applicant: DongGuan Amperex Technology Limited, Dongguan (CN)

(72) Inventors: Songcai ZHONG, Dongguan (CN); Mingliang MO, Dongguan (CN); Hongwei YAN, Dongguan (CN)

(73) Assignee: DongGuan Amperex Technology Limited, Dongguan (CN)

(21) Appl. No.: 14/220,003

(22) Filed: Mar. 19, 2014

(30) Foreign Application Priority Data
Nov. 15, 2013 (CN) 201320721104.2

(51) Int. Cl. H01M 2/02

(52) U.S. Cl. CPC H01M 2/0257; H01M 2/026; H01M 2/0262
USPC 429/163

(57) ABSTRACT

A soft-packaged lithium-ion battery includes: a battery cell, a package used for accommodating the battery cell and an electrolyte filled into the package, wherein the bottom and/or top of the battery cell are/is provided with a porous material layer. Compared with conventional art, the disclosure can realize a buffer function between the battery cell and the package by providing a porous material layer at the bottom and/or top of the battery cell, thereby reducing impact of the battery cell on the package and improving the reliability of the battery cell packaging. In addition, since the porous material layer has an excellent absorbent property, thereby increasing the contact area between the electrolyte and the battery cell, and realizing rapid infiltration of electrolyte in the battery cell with high-energy density and big thickness (thickness ≧4 mm).

### FIELD OF THE INVENTION

The disclosure belongs to the technical field of lithium-ion battery, and in particular to a soft-packaged lithium-ion battery.

### BACKGROUND OF THE INVENTION

Lithium-ion battery is the most advanced rechargeable battery in the present world. With the development of various electronic products, market demand on lithium-ion battery shows a rapid growth trend. Due to advantages of high discharge voltage, high-energy density and low self-discharge rate, lithium-ion battery is widely applied.

In conventional art, lithium-ion battery mainly adopts a liquid electrolyte. The infiltration of the liquid electrolyte in the battery cell mainly refers to transporting the electrolyte through the capillary action of the cathode, anode and separator of the battery cell on this electrolyte. For the battery cell with low-energy density and small volume, the infiltration speed of the electrolyte is acceptable. However, for the battery cell with high-energy density and big thickness (thickness≧4 mm), the electrolyte can not infiltrate the battery cell quickly under the capillary action of the cathode, anode and separator, thus impacting production efficiency. Moreover, the electrolyte can not be evenly distributed in the battery cell, thus impacting the electrochemical performance of the battery. In addition, the battery cell would collide with the package during packaging process, leading to unreliable packaging and safety hazard; besides, when the battery cell is vacuumized after packaging, the bottom of the soft-packaged lithium-ion battery probably would be shrunken.

### SUMMARY OF THE INVENTION

The disclosure aims at providing a soft-packaged lithium-ion battery in view of the defect of conventional art, wherein the electrolyte in the battery can quickly infiltrate the battery cell and can be evenly distributed in the battery cell. Through the disclosure, the reliability of battery cell packaging can be enhanced too.

In order to achieve the above aim, the disclosure adopts a technical scheme as follows.

The disclosure provides a soft-packaged lithium-ion battery, including: a battery cell, a package used for accommodating the battery cell and an electrolyte filled into the package, wherein the bottom and/or top of the battery cell are/is provided with a porous material layer.

As an improvement of the soft-packaged lithium-ion battery of the disclosure, the thickness of the porous material layer is 5 μm to 50 μm. The porous material layer has a porosity of 30% to 85% and an aperture of 1 μm to 20 μm; in addition, pores can be formed on the porous material layer manually, with aperture of 100 μm to 4750 μm and mesh number of 4 to 120.

As an improvement of the soft-packaged lithium-ion battery of the disclosure, the thickness of the porous material layer is 10 μm to 40 μm.

As an improvement of the soft-packaged lithium-ion battery of the disclosure, the thickness of the porous material layer is 20 μm.

As an improvement of the soft-packaged lithium-ion battery of the disclosure, the porous material layer selects from the group of polyethylene layer, polypropylene layer, polyvinylidene fluoride layer, polytetrafluoroethylene layer, polyacrylate layer or polyacrylamide layer.

As an improvement of the soft-packaged lithium-ion battery of the disclosure, the bottom and top of the battery cell are connected with the porous material layer through an adhesive tape layer.

As an improvement of the soft-packaged lithium-ion battery of the disclosure, the bottom and top of the battery cell are connected with the porous material layer through a binder layer.

As an improvement of the soft-packaged lithium-ion battery of the disclosure, the binder layer selects from the group of polyvinylidene fluoride layer, butadiene styrene rubber layer, polyurethane layer or polyacrylate layer.

As an improvement of the soft-packaged lithium-ion battery of the disclosure, the thickness of the battery cell is greater than or equal to 4 mm.

As an improvement of the soft-packaged lithium-ion battery of the disclosure, one end edge of the porous material layer is aligned to one side of the battery cell, while the other end edge has a distance of 1 to 5 mm to the other side of the battery cell.

Compared with conventional art, the disclosure has advantages as follows: by providing a porous material layer at the bottom and/or top of the battery cell, the disclosure can realize a buffer function between the battery cell and the package, thereby reducing impact of the battery cell on the package and improving the reliability of the battery cell packaging; the porous material layer provided at the bottom of the battery cell can support the package, thereby preventing the soft-packaged lithium-ion battery that finishes packaging from shrinking while the soft-packaged lithium-ion battery is vacuumized. In addition, when the porous material layer is provided at the bottom and/or top of the battery cell, since the porous material layer has an excellent absorbent property, part electrolyte that can not infiltrate the battery cell directly can diffuse quickly along the porous material layer under the capillary action of the porous material layer, thereby increasing the contact area between the electrolyte and the battery cell, and realizing rapid infiltration of electrolyte in the battery cell with high-energy density and big thickness (thickness≧4 mm).

### BRIEF DESCRIPTION OF THE DRAWINGS

FIG. 1 shows a structure diagram of a battery cell according to Embodiment 1 of the disclosure;

FIG. 2 shows a structure diagram of a battery cell according to Embodiment 2 of the disclosure;

FIG. 3 shows a structure diagram of a battery cell according to Embodiment 3 of the disclosure;

FIG. 4 shows a first structure diagram of a battery cell according to Embodiment 4 of the disclosure; and

FIG. 5 shows a second structure diagram of the battery cell according to Embodiment 4 of the disclosure.

### DETAILED DESCRIPTION OF THE EMBODIMENTS

The disclosure is described below in further detail in conjunction with drawings. However, the specific implementation of the disclosure is not limited to the following.

### Embodiment 1

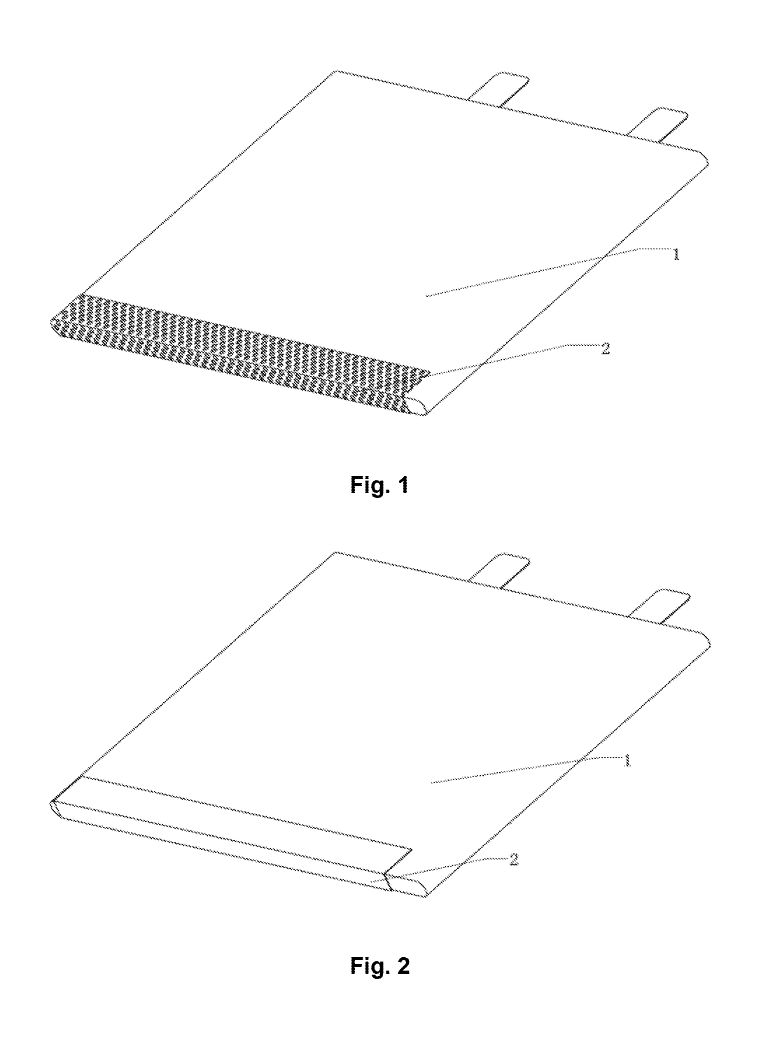

As shown in FIG. 1, a soft-packaged lithium-ion battery provided by this embodiment includes a battery cell 1, a package used for accommodating the battery cell 1 and an electrolyte filled into the package, wherein the bottom of the battery cell 1 is provided with a porous material layer 2. The section of the porous material layer 2 is in a U shape, that is to say, the porous material layer 2 is covered on the bottom of the battery cell 1 and on the lower parts of two sides (the plane along length and width directions) adjacent to the bottom. The thickness of the porous material layer 2 is 20 μm; and the bottom of the battery cell 1 is connected with the porous material layer 2 through a binder layer.

Here, the porous material layer 2 selects polypropylene layer; the binder layer selects polyacrylate layer; artificial pores are arranged on the porous material layer 2, with aperture of 1.0 mm and mesh number of 18; the thickness of the battery cell 1 is 5 mm; one end edge of the porous material layer 2 is aligned to one side of the battery cell 1, while the other end edge has a distance of 2.5 mm to the other side of the battery cell 1. Artificial pores can be realized by means of laser, needle and the like. Since the electrolyte and the package adopt common ways, they are not shown in FIG. 1.

### Embodiment 2

As shown in FIG. 2, what different from Embodiment 1 is as follows:

the porous material layer 2 selects polyvinylidene fluoride layer; the binder layer selects butadiene styrene rubber layer; the porosity of the porous material layer 2 is 55%; the thickness of the battery cell 1 is 6 mm; the thickness of the porous material layer 2 is 30 μm; one end edge of the porous material layer 2 is aligned to one side of the battery cell 1, while the other end edge has a distance of 3.5 mm to the other side of the battery cell 1.

The rest is the same as Embodiment 1, and no further description is needed here.

### Embodiment 3

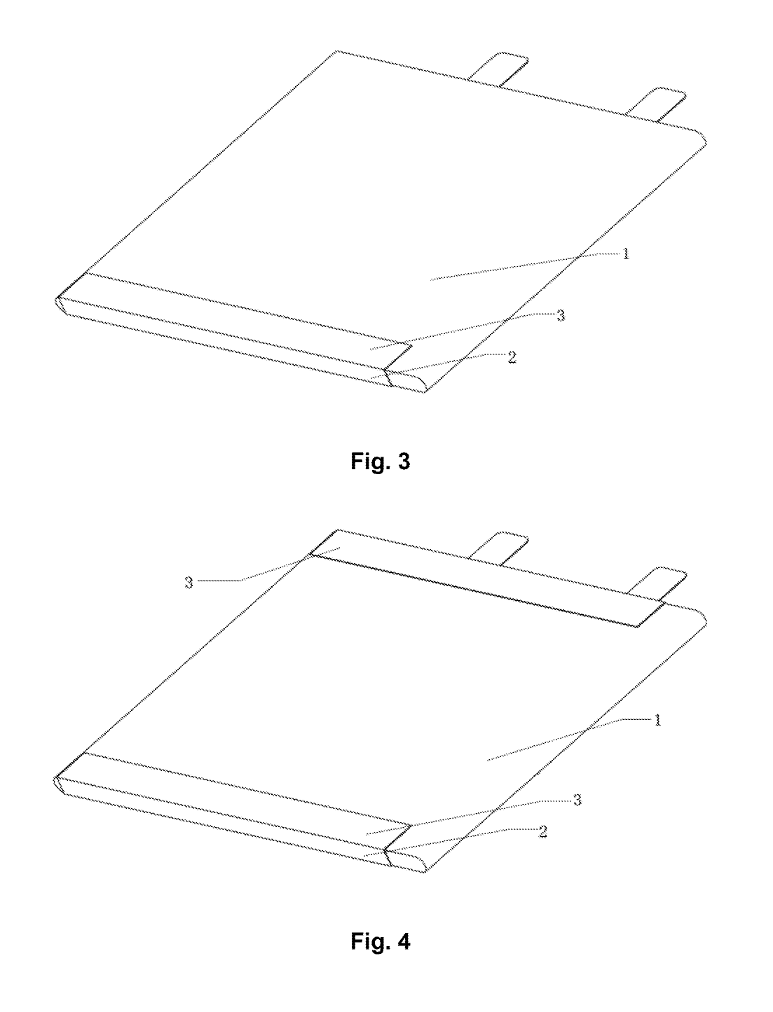

As shown in FIG. 3, what different from Embodiment 1 is as follows:

the porous material layer 2 selects polyacrylamide layer; the porous material layer 2 is connected with the bottom of the battery cell 1 through a green glue layer 3; the porosity of the porous material layer 2 is 50%; the thickness of the battery cell 1 is 4.5 mm; the thickness of the porous material layer 2 is 40 μm; one end edge of the porous material layer 2 is aligned to one side of the battery cell 1, while the other end edge has a distance of 3 mm to the other side of the battery cell 1.

The rest is the same as Embodiment 1, and no further description is needed here.

### Embodiment 4

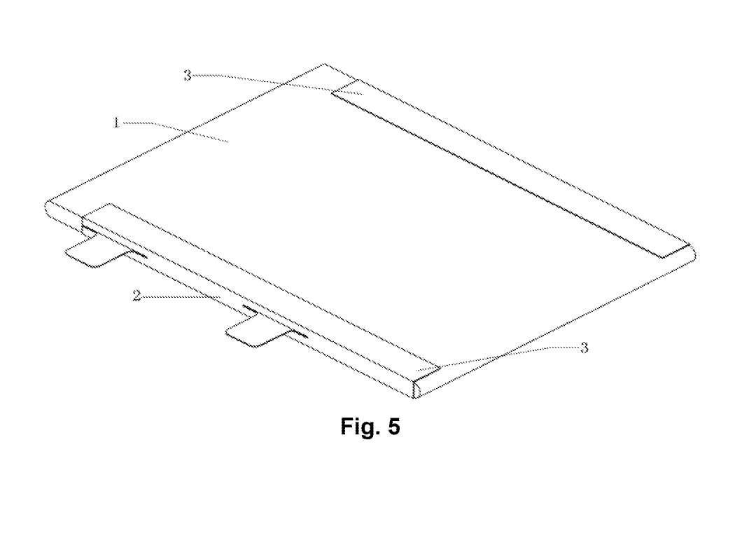

As shown in FIG. 4 and FIG. 5, a soft-packaged lithium-ion battery provided by this embodiment includes a battery cell 1, a package used for accommodating the battery cell 1 and an electrolyte filled into the package, wherein both the bottom and top of the battery cell 1 are provided with a porous material layer 2. The section of the porous material layer 2 is in a U shape. The thickness of the porous material layer 2 is 15 μm; and the bottom of the battery cell 1 is connected with the porous material layer 2 through a green glue layer 3.

Here, the porous material layer 2 selects polyethylene layer, with porosity of 50%; the thickness of the battery cell 1 is 10 mm; one end edge of the porous material layer 2 is aligned to one side of the battery cell 1, while the other end edge has a distance of 2.0 mm to the other side of the battery cell 1.

According to the discovery and revelation of the disclosure, those skilled in the art can change and modify the above implementation. Therefore, the disclosure is not limited to the specific implementation discovered and described above. Those modifications and changes made to the disclosure should be included in the protection scope of the claims of the disclosure. In addition, despite some terms are used in the description, these terms are only for illustration but to limit the disclosure.

What is claimed is:

1. A soft-packaged lithium-ion battery, including a battery cell, a package used for accommodating the battery cell and an electrolyte filled into the package, wherein the bottom and/or top of the battery cell are/is provided with a porous material layer.

2. The soft-packaged lithium-ion battery according to claim 1, wherein the thickness of the porous material layer is 5 μm to 50 μm.

3. The soft-packaged lithium-ion battery according to claim 2, wherein the thickness of the porous material layer is 10 μm to 40 μm.

4. The soft-packaged lithium-ion battery according to claim 3, wherein the thickness of the porous material layer is 20 μm.

5. The soft-packaged lithium-ion battery according to claim 1, wherein the porous material layer selects from the group of polyethylene layer, polypropylene layer, polyvinylidene fluoride layer, polytetrafluoroethylene layer, polyacrylate layer or polyacrylamide layer.

6. The soft-packaged lithium-ion battery according to claim 1, wherein the bottom and top of the battery cell are connected with the porous material layer through an adhesive tape layer.

7. The soft-packaged lithium-ion battery according to claim 1, wherein the bottom and top of the battery cell are connected with the porous material layer through a binder layer.

8. The soft-packaged lithium-ion battery according to claim 7, wherein the binder layer selects polyvinylidene fluoride layer, butadiene styrene rubber layer, polyurethane layer or polyacrylate layer.

9. The soft-packaged lithium-ion battery according to claim 1, wherein the thickness of the battery cell is greater than or equal to 4 mm.

10. The soft-packaged lithium-ion battery according to claim 1, wherein one end edge of the porous material layer is aligned to one side of the battery cell, while the other end edge has a distance of 1 to 5 mm to the other side of the battery cell.
